(19) United States
(12) Patent Application Publication
(10) Pub. No.: US 2022/0009707 A1
(43) Pub. Date: Jan. 13, 2022

(54) FLEXIBLE CONTAINER FOR PACKAGING WASTE

(71) Applicant: LINERBENNE, Nantes (FR)

(72) Inventor: Franck Milhem, Noisy Le Grand (FR)

(21) Appl. No.: 17/414,564

(22) PCT Filed: Dec. 20, 2019
(86) PCT No.: PCT/EP2019/086678

§ 371 Date: Jun. 16, 2021

(30) Foreign Application Priority Data
Dec. 21, 2018 (FR) 1873963

(51) Int. Cl. B65F 1/06; B65F 1/00

(52) U.S. Cl. CPC B65F 1/06; B65F 2240/118; B65F 1/002

(57) ABSTRACT

A flexible container for packaging waste including an inner envelope delimiting an internal volume (V) for receiving and housing the waste. The container includes a bottom wall, a top wall and at least one side wall linking the bottom and top walls, and the inner envelope includes, in the top wall, an opening that can be opened or closed using a fastener system, in which at least one flap is fixed to the inner envelope in at least one first fixing zone situated in a peripheral part of the top wall of the inner envelope, and at least one reinforcing band is fixed to the inner envelope and/or to the flap, disposed at least in a zone defined by the first fixing zone.

### TECHNICAL FIELD

The present invention relates to the field of waste packaging. The term “waste” is employed in the sense of European directive 2006/12/CE dated 5 Apr. 2006 and designates any substance or any object falling within the categories given in annex I of that directive, which the holder disposes of or has the intention or the obligation of disposing of.

It relates more particularly to the packaging of the waste resulting from the work involved in removing asbestos from constructions or public works.

It thus relates to a container, notably a flexible container, for packaging waste, and to a method for packaging waste using such a container.

### PRIOR ART

In the context of the packaging of waste, notably of asbestos, the patent application EP 3 133 033 is known which relates to a flexible packaging for solid waste with a content greater than 5 m³, composed of a mechanically strong outer envelope and a dust-tight inner envelope, each comprising a cover that can be reclosed over a pocket by closure means so as to close the packaging tightly using a system of flaps extending from the top peripheral edge of the packaging, interposed between the outer envelope and the inner envelope and covering the closure means of the inner envelope.

In the field of the invention, it is essential to be able to guarantee the sealing of the waste container when loading waste on a collection site, during transportation and during unloading on a storage site, while controlling the manufacturing costs.

The flexible containers packaging waste are disposed in a metal open carrier during loading and transportation. Some open carriers can be unloaded, on the storage site, from the transport truck, notably using an articulated arm of Ampliroll® type, requiring a low inclination during discharging, which makes it possible to maintain the integrity and therefore the sealing of the container.

However, generally, the metal open carrier with a capacity of 32 T housing the flexible container remains fixed to the transport truck and a tilting of the open carrier to discharge the flexible container with the waste takes place. In the latter case, the angle of tilt is significant, in other words the tilting of the open carrier during offloading is significant, which results in a sudden offloading and greatly increases the risk of damaging the flexible container, notably by tearing.

There is a need to benefit from flexible containers that make it possible to package and transport waste, from a collection site to a storage site, strongly and tightly, in particular asbestos waste or other waste.

### SUMMARY OF THE INVENTION

The present invention relates to a flexible container for packaging waste, notably but not exclusively, asbestos waste or other waste, comprising:
an inner envelope delimiting an internal volume for receiving and housing the waste, and comprising a bottom wall, a top wall and at least one side wall linking the bottom and top walls, the inner envelope comprising, in the top wall, an opening that can be opened or closed using a fastener system,
at least one flap fixed to the inner envelope in at least one first fixing zone situated in a peripheral part of the top wall of the inner envelope and
at least one reinforcing band fixed to the inner envelope and/or to the flap, disposed at least in a zone defined by the first fixing zone.

By virtue of the invention, the strength of the fixing zone between the flap and the top wall of the inner envelope is significantly reinforced with the reinforcing band disposed at least in the first fixing zone for the flap. Thus, notably during the discharging of the container from the open carrier in the storage site, the container can withstand tearing, despite the mechanical strains exerted on the inner envelope.

The reinforcing band is preferably superimposed on the flap and on the top wall of the inner envelope.

Preferably, the reinforcing band partially covers the or each flap and is fixed thereto. It is advantageously fixed onto an outer surface of the flap.

The reinforcing band is advantageously fixed to the inner envelope and/or to the flap by gluing, by welding, by stitching or any other fixing technique, preferably by gluing.

Preferably, the reinforcing band is fixed to the inner envelope and to the flap.

The reinforcing band can comprise, on one of its faces, an adhesive, for example a synthetic rubber resin. That allows it to be fixed notably to the flap and/or to the inner envelope. The reinforcing band preferably comprises a fibrous reinforcement, notably comprising fibers chosen from the group consisting of glass fibers, carbon fibers, aramid fibers, natural fibers and mixtures thereof, preferably glass fibers. The reinforcing band can also comprise at least one layer of a polymer, notably chosen from the group consisting of a polyolefin, polyethylene terephthalate (PET) and polyester, preferably PET. The fibrous reinforcement can be woven, non-woven and/or knitted. The thickness of the reinforcing band can lie between 0.10 mm and 0.20 mm, preferably between 0.14 mm and 0.18 mm, for example be equal to 0.16 mm. The tensile strength of the reinforcing band can be approximately 550 N/inch.

The container preferably comprises a number of flaps equal to the number of sides or edges of the top wall of the inner envelope. The container preferably comprises a number of reinforcing bands at least equal to the number of flaps.

In one embodiment, the inner envelope has a substantially parallelepipedal form, the inner envelope comprising four side walls, the container then preferably comprising four flaps, in other words one per side or edge of the rectangular top wall of the inner envelope, and four reinforcing bands, in other words one per flap.

The references to a wall or “top” or “bottom” portion are made by an inspector observing the container when the latter is resting on the ground in its waste loading position.

Said at least one side wall of the inner envelope is, for example, fixed, in a top portion, to the top wall in the first fixing zone, the top wall being notably inserted between the side wall and the flap in the first fixing zone. In this case, the flap, the top portion of the side wall and the peripheral part of the top wall are fixed, notably welded, together in the first fixing zone.

The fixing in the first fixing zone can also be made by stitching or by gluing.

The first fixing zone can be situated at a non-zero distance from the edge of the top wall of the inner envelope, said distance preferably lying between 1 mm and 30 mm, notably between 5 mm and 20 mm.

The first fixing zone can be situated at a non-zero distance from the edge of the flap, said distance preferably lying between 1 mm and 30 mm, notably between 5 mm and 20 mm.

In the case where said at least one side wall of the inner envelope is fixed, in a top portion, to the top wall in the first fixing zone, and in which the flap, the top portion of the side wall and the peripheral portion of the top wall are fixed, notably welded, together in the first fixing zone, the first fixing zone can be situated at a non-zero distance from the top edge of the side wall, said distance preferably lying between 1 mm and 30 mm, notably between 5 mm and 20 mm.

These three distances from the edge are advantageously equal to one another. There is no departure from the framework of the invention if these distances are different to one another.

The first fixing zone, in particular the welding zone, can extend over a width lying between 1 mm and 30 mm, notably between 3 mm and 20 mm.

Said at least one reinforcing band can cover a top portion of said at least one side wall.

In one embodiment, the reinforcing band covers the flap and the top portion of the side wall on a surface thereof including the first fixing zone and a surface situated in proximity to the first fixing zone, notably on either side thereof.

The flap or flaps and/or the inner envelope is or are preferably provided with fixing means to be able to fix, in at least one second fixing zone, the flap or flaps to the inner envelope after the closure thereof, the first and second fixing zones being disposed respectively on either side of the fastener system. The fixing means in this second fixing zone notably comprise an adhesive, preferably a double-sided adhesive tape.

That makes it possible to seal the closure. That also makes it possible to increase the strength of the inner envelope.

The container advantageously comprises an outer envelope forming the outer surface of the container and having, in a top part, an opening that can be opened or closed, the inner envelope being disposed inside the outer envelope, said at least one flap being inserted between the outer envelope and the inner envelope.

The outer envelope makes it possible to add strength to the container.

The outer envelope can comprise a fastener system that can comprise a slide fastener. The fastener system of the outer envelope can be present on a top wall of the outer envelope. In the latter case, and in the case where the inner envelope also comprises a slide fastener, the slide fasteners of the inner envelope and of the outer envelope have, for example, U-shaped profiles of opposing orientation.

The outer envelope can have a substantially parallelepipedal form, the outer envelope comprising a top wall and a bottom wall that are linked to one another by four side walls.

The container can comprise at least one second reinforcing band superposed at least partially on and fixed to the fastener system and the inner envelope.

The fastener system preferably comprises a slide fastener. The slide fastener is advantageously produced with a slide stitched on either side of a strip of fabric, and notably made of polyester, with a side dimension of approximately 3 cm, for example.

The fastener system can be fixed by stitching to the inner envelope. In this case, the same stitching can serve both to fix the fastener system and the second reinforcing band or bands. A plurality of rows of stitching, for example parallel to one another, can make it possible to fix the fastener system to the inner envelope and, simultaneously, the second reinforcing band or bands.

The second reinforcing band can be produced in the same material or materials as the reinforcing band.

The inner envelope can comprise at least one polymer material notably comprising polyethylene (PE), notably a film of PE or a weave of PE. It is advantageously tight to dust, to emissive and/or powdery materials, to air and to water. The inner envelope preferably has walls that are substantially parallel to the respective walls of the outer envelope, when the latter is present, in immediate proximity thereto, within the container. The various top, bottom and one or more side walls of the inner envelope together define the internal volume of the inner envelope, corresponding to the internal volume of the container. The inner envelope preferably has a parallelepipedal form. The thickness of the walls of the inner envelope can lie between approximately 200 μm and 400 μm, notably between 200 μm and 350 μm. A layer, notably glued, of expanded PE can be fixed onto the inner surface on the bottom wall of the inner envelope.

The internal volume of the container, that is to say of the inner envelope, can be greater than or equal to 3 m³, notably to 5 m³, notably to 10 m³, notably to 16 m³, even to 18 m³, notably to 24 m³, even to 35 m³.

The inner envelope can comprise zones that are thicker than others, so as to locally reinforce the mechanical strength properties, because the waste can move around with force inside the container.

The flap or flaps can be made of polymer material, notably of a film of PE, with a thickness that can lie between approximately 100 μm and 160 μm.

The outer envelope can comprise at least one polymer material, notably comprising polypropylene (PP), notably in the form of woven material, being for example produced as a sheet of PP. It advantageously has mechanical strength properties to withstand tearing. It can comprise zones that are thicker than others or comprise reinforcements, so as to locally reinforce the mechanical strength properties. In particular, it can comprise reinforcements at the edges of the front and rear walls, produced for example essentially in PP. It can have a grammage lying between approximately 190 g/m² and 300 g/m², notably between 200 g/m² and 270 g/m², depending on the dimensions of the outer envelope. The tensile strength, measured according to the ASTM D638 standard, in the warp direction, can lie between approximately 180 kgf and 240 kgf, in other words approximately 1765 N and 2355 N. The tensile strength, measured according to the ASTM D638 standard, in the weft direction, can lie between approximately 170 kgf and 240 kgf, in other words approximately 1665 N and 2355 N. The elongation, measured according to the ASTM D638 standard, can lie between approximately 18 and 20%, in the weft or warp direction.

The outer envelope can be linked to the inner envelope by at least partial bonding, notably total bonding between the bottom, side, front and rear walls of the envelopes.

The opening of the inner envelope can occupy a large part of the top wall of the inner envelope, and have three edges, including the two longitudinal edges and a third edge, linking them, in proximity to the front or rear wall of the inner envelope, substantially parallel thereto. The three edges of the opening are preferably provided with meshing teeth to allow a slide fastening (or zip fastening) of the opening.

Likewise, the opening of the outer envelope can occupy a large part of the top wall of the outer envelope, and have three edges, including the two longitudinal edges and a third edge, linking them, in proximity to the rear or front wall of the outer envelope, substantially parallel thereto. It should be noted that, preferably, the opening of the outer envelope comprises, in addition to the two longitudinal edges, a third edge which is opposite to that of the inner opening. Thus, if the opening of the inner envelope comprises a third edge in proximity to the front wall, the opening of the outer envelope preferably comprises a third edge in proximity to the rear wall. The three edges of the opening of the outer envelope are preferably provided with meshing teeth to allow a slide (or zip) fastening of the opening.

The present invention is not however limited to a particular type of fastening system and other fastening systems can be envisaged without departing from the framework of the invention.

The inner envelope can be provided, on its internal surface, notably the side wall or walls, with a plurality of anchoring points for tensioners, or elastic cables. These elastic cables can make it possible to secure the container to a metal open carrier in which the container would be disposed, with the openings of the outer and inner envelopes open, in order to facilitate the loading of the container with waste.

Another subject of the invention, according to another aspect, in combination with the above, is a method for packaging waste comprising the following steps:
disposing a flexible container as defined above, in a metal open carrier,
opening the container by opening the outer envelope and the inner envelope,
depositing the waste in the internal volume of the container,
closing the container tightly, by closing the inner envelope using the fastening system, and by fixing the flap or flaps using fixing means in the second fixing zone, when they are present, then by closing the outer envelope.

### BRIEF DESCRIPTION OF THE DRAWINGS

FIG. 1 represents, schematically and in perspective, an example of an inner envelope, closed, of a container according to the invention,

FIG. 2 represents, partially, schematically and in transverse cross-section, the inner envelope of FIG. 1 seen according to II,

FIG. 3 is a view in schematic cross-section and isolated of a reinforcing band,

FIG. 4 is an enlarged view of the detail IV of FIG. 2,

FIG. 5 is a schematic partial top view of an example of an inner envelope of a container according to the invention,

FIG. 6 is an enlarged view of the detail VI of FIG. 2, and

FIG. 7 is a schematic perspective view of an example of an outer envelope, closed, of a container according to the invention.

### DETAILED DESCRIPTION

FIG. 1 illustrates an inner envelope 2 of a container 1 according to the invention, represented closed in this figure. It has an elongate form on a longitudinal axis X, as can be seen. It delimits an internal volume V of the container for housing waste.

The inner envelope 2 is made of a polymer material, notably of polyethylene, notably of a material that is tight to dust. The inner envelope 2 is made, in this example, of a film of PE, having a thickness of approximately 350 μm.

The inner envelope 2 has a parallelepipedal form. The inner envelope 2 comprises a bottom wall 4 and a top wall 5 and four side walls linking the bottom 4 and top 5 walls, including a front side wall 6, a rear side wall 7 and two side lateral walls 8 and 9. The inner envelope 2 has an outer surface 10 and an inner surface 11. The inner envelope 2 has a total height Hᵢ, a width lᵢ and a length Lᵢ, with Hᵢ=1.6 m, lᵢ=2.5 m and Lᵢ=8.8 m in this example.

The top wall 5 is provided with an opening 51 for the introduction of the waste, defined by three edges in this example, namely two longitudinal edges 52 and 53 parallel to the longitudinal axis X. It comprises a third, rear edge 54, linking the edges 52 and 53 and extending in proximity to the rear wall 55. These three edges are situated in proximity to a peripheral part 92 of the top wall 5. The opening 51 can be opened or closed using a fastening system 510 disposed along the longitudinal edges 52 and 53 and the rear edge 54. In this example, the fastening system 510 of the inner envelope 2 comprises a slide fastening, with a slide 511 and a strip of fabric 512 made of polyester to which the slide 511 is stitched, as can be seen in FIGS. 5 and 6. Cords 80 of sufficient length are provided to allow an operator to actuate the fastening system 510 from the bottom of the container or facilitate this actuation.

The container 1 comprises at least one flap, in this example a plurality of flaps, four of them in this example, namely a rear flap 70, a front flap 71 disposed opposite, and also two side flaps 72 and 73. The flaps are made in this example of a polymer material, notably of a polyethylene film, reinforced or not, having a thickness that can lie between approximately 100 μm and 160 μm.

The rear 70 and front 71 flaps are identical to one another. The side flaps 72 and 73 are identical to one another. The flaps 70 and 71 are of a width equal to the width lᵢ of the inner envelope 2. The flaps 72 and 73 are of a width equal to the length Lᵢ of the inner envelope 2.

The flaps 70, 71, 72 and 73 are fixed to the top wall 5, in this example by welding, in a first fixing zone 90 situated in the peripheral part 92 of the top wall 5 of the inner envelope 2, as can be seen in FIG. 1.

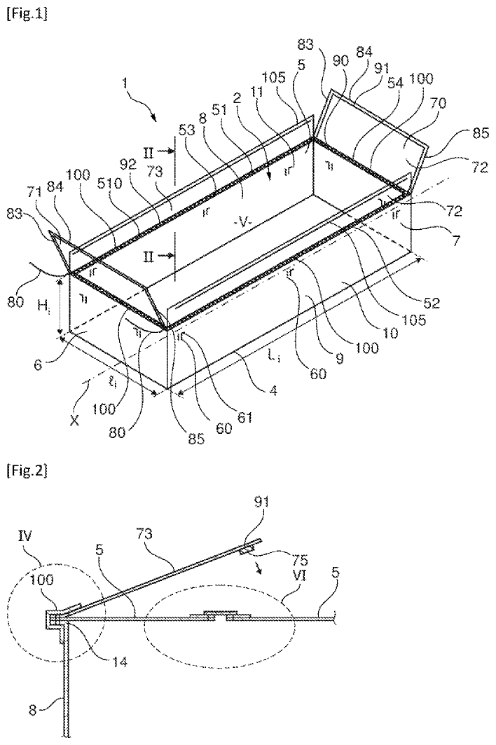

In this example, the side walls 6, 7, 8 and 9 of the inner envelope 2 are also fixed, in a top portion 14, to the top wall 5 in the first fixing zone 90, as can be seen in particular in FIG. 2. They are fixed also be welding, done simultaneously with that which links the flaps and the top wall 5 in the first fixing zone 90.

The top wall 5 is inserted, as can be seen in FIGS. 2 and 4, between the side wall 6, 7, 8 or 9 and the corresponding flap 71, 70, 73 and 72, respectively. Still in this example, the first fixing zone 90 is situated at a distance d₁, that is to say extends at a distance d₁ from the edge 95 of each flap, at a distance d₂ from the peripheral edge 96 of the top wall 5 and at a distance d₃ from the edge 97 of each side wall. In this example d₁=d₂=d₃=10 mm approximately.

The first fixing zone 90, formed in this example by the weld zone, extends over a width w equal to approximately 10 mm.

It should be noted that there is no departure from the framework of the invention if the top wall 5 is produced in a single piece with at least one of the side walls 6, 7, 8 and 9.

The container 1 also comprises at least one reinforcing band 100 fixed to the flap 70, 71, 72 and 73 and/or to the inner envelope 2 disposed at least partially in the first fixing zone 90, that is to say in a zone defined by the first fixing zone 90.

Each reinforcing band 100 is superposed at least partially on the flap 70, 71, 72 and 73 and on the top wall of the inner envelope 2. The reinforcing band 100 is, in this example, fixed to each flap 70, 71, 72 and 73, specifically to the outer surface of these flaps, and to the inner envelope 2, specifically to each top portion 14 of the side walls 6, 7, 8 and 9.

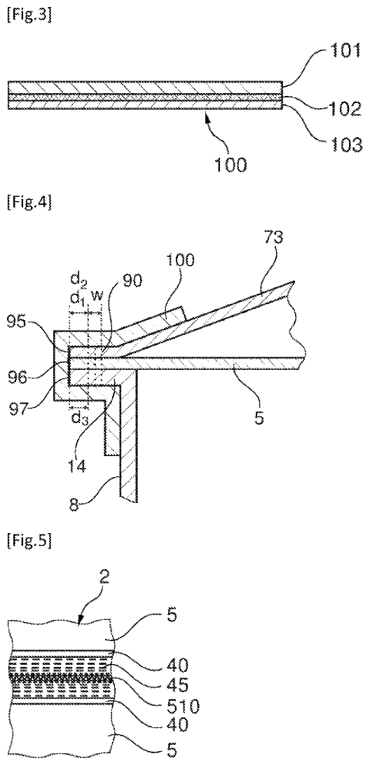

The reinforcing band 100 is, in this embodiment, fixed by gluing using an adhesive 103, for example a synthetic rubber resin, disposed in layer form on one of its faces. The reinforcing band 100, represented on its own in FIG. 3, also comprises a polymer film 101, in this example a film of polyethylene terephthalate (PET), and a fibrous reinforcement 102 of glass fibers in this example. Still in this example, as can be seen in FIG. 1, the container 1 comprises four reinforcing bands 100, one for each flap.

The presence of the reinforcing bands 100 makes it possible to reinforce the strength of the container 1, particularly in the first fixing zone 90. As can be seen in FIGS. 2 and 4, a fold is formed around the first fixing zone 90 on the periphery of the top wall 5. The reinforcing bands 100 cover the first fixing zone 90 and also surfaces of the side walls and of the flaps located on either side thereof, as can be seen notably in FIG. 4.

The fixing, notably the weld, in the first fixing zone 90, is advantageously formed continuously over the entire length and width of the inner envelope 2.

The container 1 comprises a second fixing zone 91 disposed on the other side of the fastening system 510 with respect to the first fixing zone 90, for each flap. The flaps 70, 71, 72 and 73 each comprise fixing means 75 consisting in this example of an adhesive, notably a double-sided adhesive tape, for them to be fixed to the inner envelope 2 in the second fixing zone 91 in the direction indicated by the arrow in FIG. 2. These fixing means 75 are disposed, as can be seen in FIG. 1, along at least one edge of the flap, parallel thereto. The fixing means 75 are in the form of a parallel band in proximity to the edge 105 of the flaps 72 and 73. The fixing means 75 are in the form of three bands parallel to the three edges 83, 84 and 85 of the flaps 70 and 71.

The flaps 70, 71, 72 and 73 entirely cover the fastening system 510, when in closed position, creating a seal at the fastening of the inner envelope 2.

The container 1 also comprises at least one secondary reinforcing band 40, in the example illustrated several second reinforcing bands 40 as can be seen in FIGS. 2, 5 and 6, disposed on either side of the fastening system 510. As can be seen in FIGS. 5 and 6, in more detail, the top wall 5 of the inner envelope 2 is stitched using stitches 45, in the form of three rows of stitching in this example, to the fastening system 510, on either side of the corresponding edge of the opening 51. Between the top wall 5 and the fastening system 510 there is inserted a second reinforcing band 40, fixed to each of them by the same stitch 45. The second reinforcing bands 40 are made of a film of polyethylene terephthalate (PET) reinforced with glass fibers. The presence of these second reinforcing bands 40 makes it possible to reinforce the strength of the inner envelope 2, particularly at the stitches 45 which can embrittle the inner envelope 2. At least one of the faces 47, even both of the faces 47 and 48, of the reinforcing band or bands 40, is coated with an adhesive, for example a synthetic rubber resin.

The inner envelope 2 is also provided in this example with a plurality of anchoring points 60 for elastic cables 61 or tensioners that can be seen in FIG. 1. The anchoring points 60 are fixed over the entire perimeter of the inner surface 11 of the inner envelope 2, that is to say on the four side walls 6, 7, 8 and 9. The elastic cables 61 can be fixed removably, in the open position of the container 1, to fixing points present on a metal open carrier housing the container 1 when being loaded with waste.

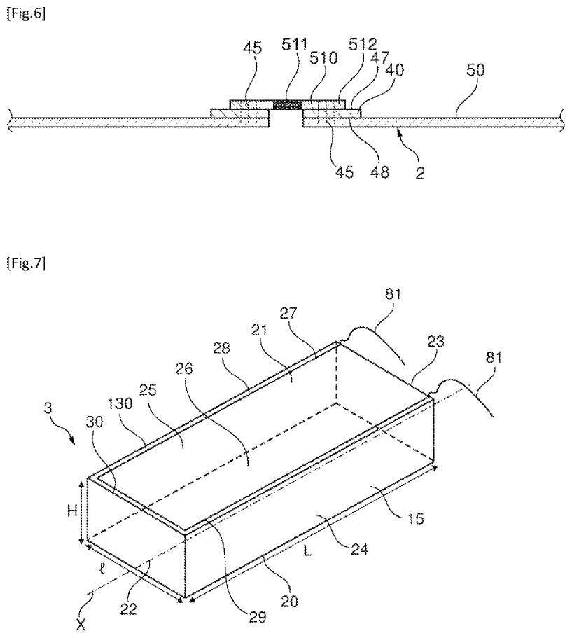

The inner envelope 2, in this embodiment, is intended to be disposed inside an outer envelope 3, represented in FIG. 7, within the container 1.

The outer envelope 3 defines an outer surface 15 of the container 1. It has an elongate form along the longitudinal axis X, as can be seen.

In the example illustrated, the outer envelope 3 has a parallelepipedal form, with a bottom wall 20 and a top wall 21, linked to one another by four side walls, namely a front side wall 22, a rear side wall 23 and two lateral side walls 24 and 25. The side walls 22 to 25 define the total height H of the outer envelope 3 and therefore of the container 1, substantially equal to Hᵢ in this example. The length L of the outer envelope 3, in other words the length of each side wall 24 or 25 in this example, is substantially equal to Lᵢ. The width l of the outer envelope 3 corresponding to the width of the front 22 or rear 23 side wall is substantially equal to lᵢ. The dimensions of the inner envelope 2 can be different, notably less than those of the outer envelope 3, without departing from the framework of the invention.

The outer envelope 3 has an inner surface 26.

The top wall 21 is occupied over a large part of its surface by an opening 27 defined by three edges, namely two longitudinal edges 28 and 29, parallel to the longitudinal axis X, and a front edge 30 linking them, in proximity to the front side wall 22 in this example, at right angles to the longitudinal axis X. The opening 27 can be opened or closed using a fastening system 130 along the longitudinal edges 28 and 29 and front edge 30. The fastening system 130 of the outer envelope 3 comprises a slide fastening in this example. Cords 81 of sufficient length are provided to allow an operator to actuate the fastening system 130 from the bottom of the container or facilitate this actuation.

The outer surface 10 of the inner envelope 2 faces the inner surface 26 of the outer envelope 3. The inner envelope 2 is disposed in the outer envelope 3 in such a way that the front side wall 6 is located alongside the front side wall 22 and the rear side wall 7 is alongside the rear side wall 23. The opening 51 of the inner envelope 2 is substantially superposed on the opening 27 of the outer envelope 3 within the container 1.

The outer envelope 3 is made of woven polymer material, notably of a sheet of PP. The grammage of the outer envelope 3, in this example, approximately 270 g/m². The outer envelope 3 has a mechanical strength.

The open position of the container 1 corresponds to the open position of the opening 27 and of the opening 51, simultaneously. The closed position of the container 1 corresponds to the closed position of the opening 27 and of the opening 51, simultaneously.

It should be noted that the edge 30 of the opening 27 is situated opposite the edge 54 of the opening 51, the first being on the side of the front side wall 22 whereas the second is on the side of the rear side wall 7. The opening 27 opens on the side of the rear side wall 23 whereas the opening 51 opens on the side of the front side wall 6.

When using the container 1, for packaging waste, the following steps are implemented:
the flexible container 1 is disposed in a metal open carrier,
the container 1 is opened by opening the outer envelope 3 and the inner envelope 2,
the waste is deposited in the internal volume V,
the container is closed tightly, by closing the inner envelope 2 using the fastening system 510, by fixing the flaps 70, 71, 72, 73 using the fixing means 75 in the second fixing zone 91, then by closing the outer envelope 3.

The invention is not limited to the example which has just been described.

The inner envelope 2 can comprise reinforcing pieces disposed at each of its corners on its inner surface and/or its outer surface, fixed by welding or gluing, for example.

The inner and outer envelopes can have another form, for example cylindrical with a single circular side wall, or another form.

1. A flexible container for packaging waste comprising:
an inner envelope delimiting an internal volume for receiving and housing the waste, and comprising a bottom wall, a top wall and at least one side wall linking the bottom and top walls, the inner envelope comprising, in the top wall, an opening that can be opened or closed using a fastener system,
at least one flap fixed to the inner envelope in at least one first fixing zone situated in a peripheral part of the top wall of the inner envelope and
at least one reinforcing band fixed to the inner envelope and/or to the flap, disposed at least in a zone defined by the first fixing zone.

2. The container as claimed in claim 1, wherein the reinforcing band partially covers the or each flap and is fixed thereto.

3. The container as claimed in claim 1, wherein the reinforcing band comprises an adhesive on one of its faces.

4. The container as claimed in claim 1, wherein the reinforcing band comprises a fibrous reinforcement and at least one layer of a polymer.

5. The container as claimed in claim 1, wherein said at least one side wall of the inner envelope is fixed, in a top portion, to the top wall in the first fixing zone, the top wall being inserted between the side wall and the flap in the first fixing zone.

6. The container as claimed in claim 5, wherein the flap, the top portion of the side wall and the peripheral part of the top wall are welded together in the first fixing zone.

7. The container as claimed in claim 1, wherein the first fixing zone is situated at a non-zero distance from the edge of the top wall of the inner envelope, said distance lying between 1 mm and 30 mm.

8. The container as claimed in claim 1, wherein the first fixing zone is situated at a non-zero distance from the edge of the flap, said distance lying between 1 mm and 30 mm.

9. The container as claimed in claim 5, wherein the first fixing zone is situated at a non-zero distance from the top edge of the side wall, said distance lying between 1 mm and 30 mm.

10. The container as claimed in claim 1, wherein the first fixing zone extends over a width lying between 1 mm and 30 mm.

11. The container as claimed in claim 1, wherein the reinforcing band covers a top portion of said at least one side wall.

12. The container as claimed in claim 5, wherein the reinforcing band covers a top portion of said at least one side wall and wherein the reinforcing band covers the flap and the top portion of the side wall on a surface thereof including the first fixing zone and a surface situated in proximity to the first fixing zone.

13. The container as claimed in claim 1, the flap or flaps and/or the inner envelope being provided with fixing means to be able to fix, in at least one second fixing zone, the flap or flaps to the inner envelope after the closure thereof, the first and second fixing zones being disposed respectively on either side of the fastener system.

14. The container as claimed in claim 1, comprising an outer envelope forming the outer surface of the container and having, in a top part, an opening that can be opened or closed, the inner envelope being disposed inside the outer envelope, said at least one flap being inserted between the outer envelope and the inner envelope.

15. The container as claimed in claim 1, comprising at least one second reinforcing band superposed at least partially on and fixed to the fastener system and the inner envelope.
